(19) United States
(12) Patent Application Publication
(10) Pub. No.: US 2004/0266350 A1
(43) Pub. Date: Dec. 30, 2004

(54) Communication apparatus using bluetooth wireless communication and method for controlling the same

(75) Inventor: Jae-Hyoung Kim, Anyang-shi (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., KYUNGKI-DO (KR)

(21) Appl. No.: 10/697,470

(22) Filed: Oct. 30, 2003

(30) Foreign Application Priority Data
Jun. 30, 2003 (KR) 43854/2003

(51) Int. Cl. H04B 1/44; H04M 3/42; H04Q 7/20

(52) U.S. Cl. 455/41.2; 455/415; 455/435.1; 455/462

(57) ABSTRACT

A communication apparatus and method are disclosed using Bluetooth wireless communication to control a Bluetooth terminal having a Bluetooth module to perform wired communication. The apparatus includes a Bluetooth wireless terminal having a Bluetooth module, a wired phone, and a wired network. The method uses Bluetooth wireless communication to control the Bluetooth wireless terminal to receive a wired communication service by: allowing a user to register a Bluetooth ID of the Bluetooth wireless terminal in the wired phone; upon receiving a wired communication request signal from the Bluetooth wireless terminal, determining with the wired phone whether the Bluetooth wireless terminal is previously registered; and connecting the Bluetooth wireless terminal with the wired network if the Bluetooth wireless terminal is previously registered.

### PRIORITY

This application claims priority to an application entitled “COMMUNICATION APPARATUS USING BLUETOOTH WIRELESS COMMUNICATION AND METHOD FOR CONTROLLING THE SAME”, filed in the Korean Intellectual Property Office on Jun. 30, 2003 and assigned Serial No. 2003-43854, the contents of which are hereby incorporated by reference.

### BACKGROUND OF THE INVENTION

1. Field of the Invention

The present invention relates to a communication apparatus and method using Bluetooth wireless communication, and more particularly to a communication apparatus and method for wirelessly controlling a Bluetooth terminal having a Bluetooth module to perform wired communication.

2. Description of the Related Art

Following the current trend of rapidly growing demand for a variety of communication devices with the spread of a large number of mobile communication terminals, the number of functions requested by users has also rapidly increased. Therefore, numerous manufacturers fabricate wireless or mobile terminals upon receiving requests from users. Recently, there has been developed a wireless or mobile terminal having a Bluetooth chip to provide a user with a local area wireless communication service. The Bluetooth wireless technology is an exemplary mobile communication standard for controlling a variety of mobile terminals, for example, a mobile phone, a mobile PC, and other mobile devices, to wirelessly communicate with each other within a short distance or small area at a low cost, and for performing wireless communication of voice or other data between a variety of digital devices without interconnecting the digital devices using a physical cable. For example, the Bluetooth wireless communication technique is adapted to mobile phones or laptops, such that the mobile phones or laptops can be interconnected with each other without using a cable. Most digital equipment, for example, PDAs (Personal Digital Assistants), desktop computers, facsimiles, keyboards, and Joysticks, can function as Bluetooth systems if needed.

Many users use a function for storing a phone number in their mobile terminals, such that few users currently take note of a desired phone number in a phone book. The users search for their desired phone number from among a plurality of phone numbers pre-stored in their mobile terminals, and can immediately establish a call connection state with a called party having found the phone number, such that they need not memorize phone numbers other than a few frequently-used phone numbers. Therefore, most users prefer to use a mobile phone rather than a wired telephone even though they are at home or at an office, because most desired phone numbers are pre-stored in mobile phones of individual users and the users prefer to press a one-touch call button associated with a found phone number. In more detail, due to convenient portability of a mobile phone, a user close to a general wired phone prefers to use his or her mobile phone rather than a wired phone, resulting in reduction of a usage frequency of the wired phone and increased usage frequency of the mobile phone. That is, most users like to gain access to a macro cell for wireless communication using their mobile or cordless phones, instead of using a general wired phone. In this way, the number of such wireless communication calls has rapidly increased, but the number of such wired communication calls has remarkably reduced, resulting in reduction of usage frequency of typical wired networks. Furthermore, most users like to use a wireless communication network instead of wired communication, resulting in unnecessary charges assessed to users.

Most conventional users establish a call connection state with another party using their mobile terminals instead of using a wired phone even though they are at home or an office, resulting in an increased amount of BTS (Base Transceiver System) load and unnecessary charges assessed to users due to high charges of mobile phone calls.

### SUMMARY OF THE INVENTION

Therefore, the present invention has been made in view of the above problems, and it is an object of the present invention to provide a communication apparatus and method for reducing a phone call charge.

It is another object of the present invention to provide a communication apparatus and method for connecting a Bluetooth wireless terminal with a wired phone using a Bluetooth communication technique, and performing wired communication over a wired network by means of the Bluetooth wireless terminal.

It is yet another object of the present invention to provide a subway broadcast method and apparatus for transmitting video signals and a variety of content to mobile communication terminals of subway passengers using a Bluetooth signal.

In accordance with one aspect of the present invention, the above and other objects can be accomplished by the provision of a communication apparatus using Bluetooth wireless communication, comprising: a Bluetooth wireless terminal having an ID (Identification) key for transmitting a communication request signal to a wired phone by means of a first Bluetooth module and a Bluetooth communication process, and requesting a communication service from the wired phone by means of the Bluetooth module upon receiving the ID key; and the wired phone having a second Bluetooth module, and connecting the Bluetooth wireless terminal with a wired network upon receiving the communication request signal from the Bluetooth wireless terminal.

In accordance with another aspect of the present invention, there is provided a communication method using Bluetooth wireless communication in a communication system comprised of a Bluetooth wireless terminal having a Bluetooth module, a wired phone, and a wired network, the method controlling the Bluetooth wireless terminal to receive a communication service, comprising the steps of: a) allowing a user to register a Bluetooth ID of the Bluetooth wireless terminal in the wired phone; and b) upon receiving a communication request signal from the Bluetooth wireless terminal, allowing the wired phone to determine whether the Bluetooth wireless terminal is previously registered, and connecting the Bluetooth wireless terminal with the wired network if the Bluetooth wireless terminal is previously registered.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a communication system for controlling a Bluetooth wireless terminal to perform wired communication using a wired phone in accordance with a preferred embodiment of the present invention;

FIG. 2 is a block diagram of a Bluetooth wireless terminal having a Bluetooth module and a wired phone in accordance with a preferred embodiment of the present invention;

FIG. 3 depicts the appearance of a wired phone in accordance with a preferred embodiment of the present invention;

FIG. 4 is a flow chart illustrating a registration procedure for providing the Bluetooth wireless terminal with a wired communication service using a wired phone in accordance with a preferred embodiment of the present invention;

FIG. 5 is a flow chart illustrating a cell search procedure between the Bluetooth wireless terminal entering a Bluetooth home cell and the wired phone in accordance with a preferred embodiment of the present invention;

FIG. 6 is a flow chart illustrating a wired communication procedure between the Bluetooth wireless terminal and the wired phone in accordance with a preferred embodiment of the present invention; and

FIG. 7 is a flow chart illustrating a call setup procedure between the wired phone and the Bluetooth wireless terminal when the wired phone receives an incoming call signal in accordance with a preferred embodiment of the present invention.

### DETAILED DESCRIPTION OF THE PREFERRED EMBODIMENTS

Now, preferred embodiments of the present invention will be described in detail with reference to the attached drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

It should be noted that the Bluetooth communication technique applied to the present invention is an international communication standard for use in local area communication. The Bluetooth communication technique mainly uses a data transfer distance of about 10 m, and has a maximum communication distance of 100 m. Use of the maximum communication distance of 100 m is accompanied by high power consumption. An available frequency band of the Bluetooth communication technique is an ISM (Industrial Scientific Medical) band of 2.4 GHz. Because a Bluetooth terminal uses a high radio frequency, its output signal can pass through materials other than metal to establish a call connection state with a counterpart terminal. A FHSS (Frequency Hop Spread Spectrum) scheme is adapted as a transfer scheme of the Bluetooth terminal. The Bluetooth terminal is designed to be minimally affected by frequency interference or fading, has a data transfer rate of about 1 Mbps in the case of a synchronous system, and has a data transfer rate of about 721 kbps in the case of an asynchronous system. Further, the Bluetooth communication technique can interconnect a maximum of 7 devices within a small range such as a piconet, and 225 devices can be constructed in the form of a network. The audio or voice signal can provide a maximum of three channels in addition to data channels.

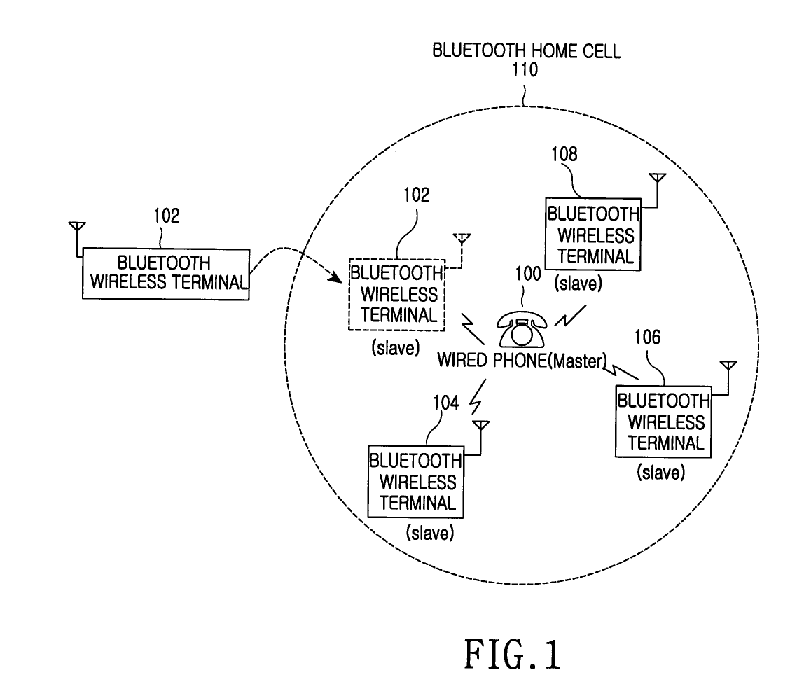

FIG. 1 is a block diagram of a communication system for controlling a Bluetooth wireless terminal to perform wired communication using a wired phone in accordance with a preferred embodiment of the present invention. The communication system includes a wired phone 100 serving as a master, and a plurality of Bluetooth wireless terminals 102, 104, 106 and 108 serving as slaves. Although the present invention exemplarily describes only four Bluetooth wireless terminals for the convenience of description, the four Bluetooth wireless terminals can be connected to a maximum of 7 slaves for use in such a piconet, or can be connected to a maximum of 225 slaves in a scatternet. In a Bluetooth home cell 110 shown in FIG. 1, a prescribed Bluetooth wireless terminal 102 gains access to a wired network using a wired phone 100 serving as a master according to a Bluetooth communication scheme within a specific area such as a home or office, such that wired communication can be established over the wired network using the wired phone 100.

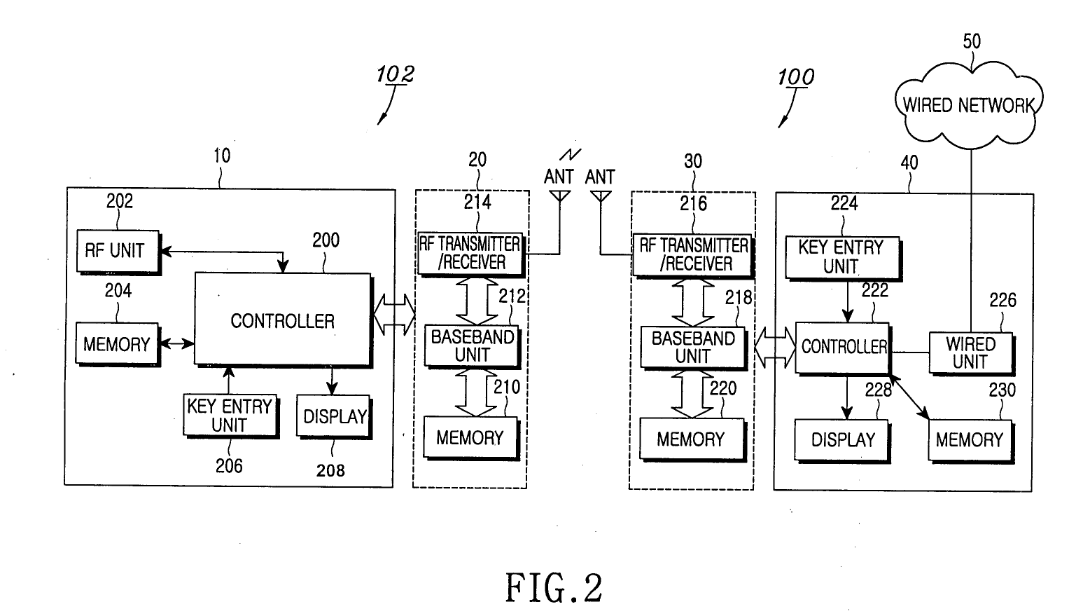

A Bluetooth wireless terminal 102 for performing wired communication over a wired network and the wired phone 100 will now be described with reference to FIG. 2. FIG. 2 is a block diagram of the Bluetooth wireless terminal 102 having a Bluetooth module and the wired phone 100 in accordance with a preferred embodiment of the present invention. Although the present invention adapts a wired phone 100 as a master, the master may be any kind of phones.

Referring to FIG. 2, the Bluetooth wireless terminal 102 is comprised of a mobile phone module 10 and a Bluetooth module 20. The mobile phone module 10 is comprised of a controller 200, a RF unit 202, a memory 204, a key entry unit 206, and a display 208. The controller 200 processes a variety of functions (e.g., a phone call function and a message or data communication function), controls overall operations of the Bluetooth wireless terminal 102, and controls wired communication over a wired network by establishing Bluetooth communication with the wired phone 100. In more detail, if a user enters his or her ID information for receiving a wired communication service using the key entry unit 206, then the controller 200 transmits a signal requesting the wired communication service to the wired phone 100 using the Bluetooth module 20. The controller 200 enables a phone number entered by the user to be transferred to the wired phone 100, such that a call connection trial signal is transferred to the wired network via the wired phone 100. The RF unit 202 is controlled by the controller 200. If a reception signal of an RF channel is transferred from an antenna ANT, the RF unit 202 converts the reception signal into downstream data, identifies information of the downstream data, and outputs the identified information to the controller 200. The memory 204 stores a program executed at the controller 200, or temporarily stores data processed by the program. The key entry unit 206 includes a plurality of number keys 0˜9 and a plurality of function keys composed of a menu key, a call send key, a deletion key, an end key, specific characters keys # and *, and a volume control key. The key entry unit 206 transmits key entry data corresponding to a user-selected key to the controller 200. Particularly, the Bluetooth wireless terminal 102 includes a prescribed key corresponding to a specific ID number needed to perform a wired communication service by means of the wired phone 100. The display 208 displays a process for executing a wired communication service upon receiving a control signal from the controller 200. The Bluetooth module 20 of the Bluetooth wireless terminal 102 is comprised of a baseband unit 212 accessing the mobile phone module 10, and a memory 210 for storing a program controlling an operation of the baseband unit 212. The Bluetooth module 20 further includes an RF transmitter/receiver 214 connected to the baseband unit 212 to modulate and demodulate data, and an antenna ANT connected to the RF transmitter/receiver 214 connected to the baseband unit 212 to transmit and receive data to or from the RF transmitter/receiver 214.

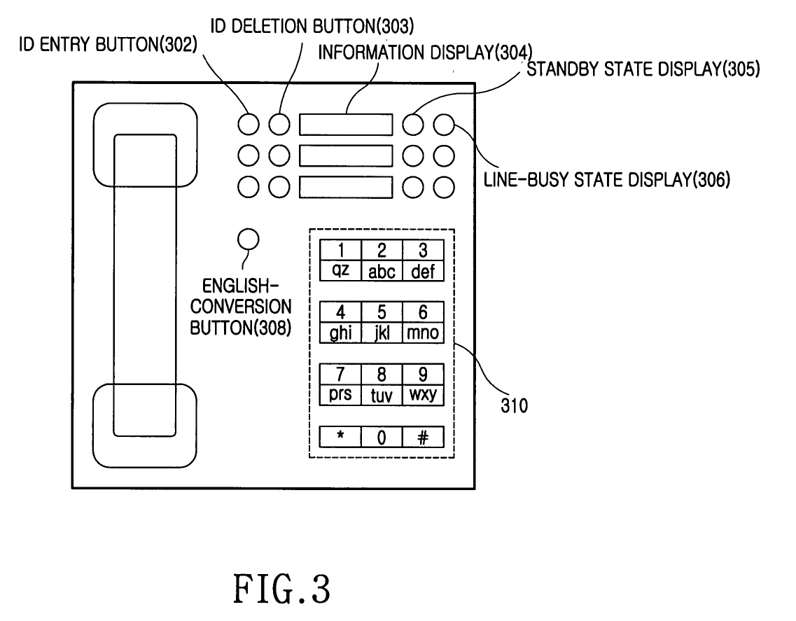

In the meantime, the wired phone 100 is comprised of a Bluetooth module 30 and a phone main body 40. The Bluetooth module 30 is similar to that of the mobile phone terminal 102 functioning as a Bluetooth wireless terminal, and includes an antenna ANT for receiving an RF signal from an external part, and an RF transmitter/receiver 216 for converting the received RF signal into digital data. The Bluetooth module 30 includes a baseband unit 218 connected to the RF transmitter/receiver 216 to process digital data received from the RF transmitter/receiver 216, and a memory 220 for storing a program controlling operations of the baseband unit 218. The phone main body 40 includes a controller 222 connected to the baseband unit 218 of the Bluetooth module 30, a wired unit 226 for transmitting/receiving a phone call signal over the wired network, and a key entry unit 224 for registering a Bluetooth ID of the Bluetooth wireless terminal 102. The display 228 displays a procedure for providing a user with a wired communication service. Particularly, the key entry unit 224 of the wired phone 100 includes an ID entry button 302 for entering an ID of the Bluetooth wireless terminal 102, an ID deletion button 303 for deleting the ID, an English-conversion button 308, and a character entry unit 310, as shown in FIG. 3. The display 228 includes an information display 304, a standby state display 305, and a line-busy state display 306, also as shown in FIG. 3.

The key entry unit 224 and the display 228 will now be described with reference to FIG. 3. FIG. 3 depicts the appearance of the wired phone 100 having the Bluetooth module in accordance with a preferred embodiment of the present invention. The wired phone 100 includes a prescribed registration device and a prescribed display that allow the Bluetooth wireless terminal 102 to access the wired phone 100 in such a way that a wired communication service is supplied to the Bluetooth wireless terminal 102. Such a registration device is , for example, the key entry unit 224 shown in FIG. 2, which is composed of an ID entry button 302, an ID deletion button 303, an English-conversion button 308, and a character entry button group 310. The display device is, for example, the display 228 shown in FIG. 2, which is composed of an information display 304, a standby state display 305, and a line-busy state display 306. The ID entry button 302 is adapted to store a Bluetooth ID for identifying information of the Bluetooth module 20 contained in the Bluetooth wireless module 102 in the memory 220 of the wired phone 100. The ID deletion button 302 is adapted to delete a Bluetooth ID stored in the memory 220. Because a unique ID of the Bluetooth module is composed of a combination of English letters and numerals, an English-conversion button 308 is adapted to enter the Bluetooth ID in the wired phone 100. In the meantime, in the case of entering such a Bluetooth ID of the Bluetooth wireless terminal 102, an ID entry button 302 is firstly pressed and a necessary ID is entered using the English-conversion button and the character entry button group 310. In the case of deleting an entry Bluetooth ID, the ID deletion button 303 is firstly pressed and the user deletes a desired Bluetooth ID from the memory 220 of the wired phone 100. If the Bluetooth wireless terminal 102 enters a Bluetooth home cell 110, the wired phone 100 serving as a master performs an inquiry process for Bluetooth initialization, and the wired phone 100 and the Bluetooth wireless terminal 102 enter a standby state. In this case, the Bluetooth ID of the Bluetooth wireless terminal 102 entering the Bluetooth home cell 110 is displayed on the display 304, and at the same time the standby state display 305 composed of LEDs (e.g., red, blue, and green LEDs) is switched on. Therefore, a user can visually recognize that his or her Bluetooth wireless terminal 102 is connected to the wired phone 100. That is, the user can visually recognize a standby state for enabling the Bluetooth wireless terminal 102 to access the wired phone 100 to perform wired communication. When the Bluetooth wireless terminal 102 gains access to the wired phone 100 and performs wired communication over a wired network, a Bluetooth ID of a Bluetooth terminal which establishes a call connection state with the wired phone 100 is displayed on the information display 304, and an LED of the line-busy state display 306 is switched on, such that the user can visually recognize that his or her Bluetooth wireless terminal has established a wired communication state. In more detail, the user can visually recognize state information of the Bluetooth wireless terminals currently connected to the wired phone by visually checking information of the information display 304, the standby state display 305, and the line-busy state display 306.

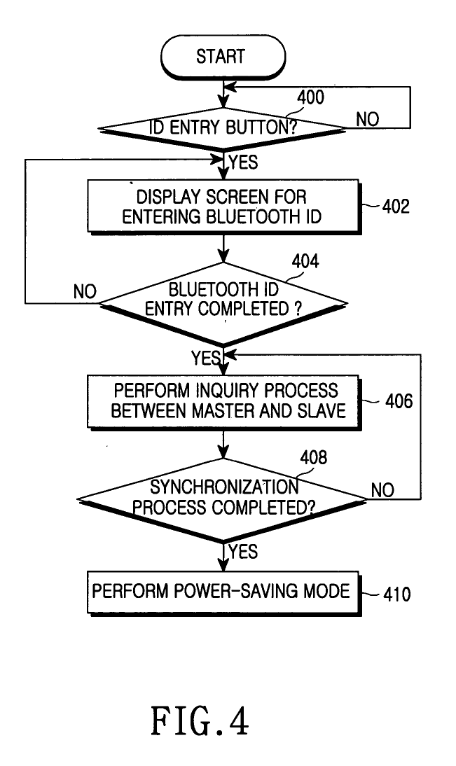

ID information (i.e., a Bluetooth ID) of the Bluetooth wireless terminal 102 must previously register in the wired phone 100, such that the Bluetooth wireless terminal 102 can gain access to the wired phone 100 to perform wired communication. There is a need for the Bluetooth wireless terminal 102 to perform its initial registration process. A procedure for controlling the Bluetooth wireless terminal 102 to register the Bluetooth ID in the wired phone 100 will now be described with reference to FIGS. 2 to 4. FIG. 4 is a flow chart illustrating such a registration procedure for providing the Bluetooth wireless terminal 102 with a wired communication service using the wired phone 100 in accordance with a preferred embodiment of the present invention.

If a user purchases a new Bluetooth wireless terminal 102 and a new wired phone 100, or wishes his or her Bluetooth wireless terminal 102 to register in the wired phone 100, the steps shown in FIG. 4 are performed. According to the Bluetooth communication of the present invention, the wired phone 100 is fixed to a master, and the Bluetooth wireless terminal 102 is fixed to a slave, such that the wired phone 100 denotes the master, and the Bluetooth wireless terminal 102 denotes the slave.

The controller 222 of the wired phone 100 serving as a master determines whether the user presses the ID entry button 302 for entering a Bluetooth ID at step 400. If the ID entry button 302 is pressed at step 400, a display screen for entering a Bluetooth ID of the slave 102 is displayed on the information display 304. For example, information “Bluetooth ID:_” is displayed on the information display 304 at step 402. The controller 222 determines whether the Bluetooth ID entry is completed at step 404. In this case, the user presses an acknowledge button to indicate that Bluetooth ID is completely entered. Function keys ‘→’ and ‘←’ are adapted to change a cursor location to another location on a display screen when entering such a Bluetooth ID. For the convenience of description, the acknowledge button and the function keys are omitted in the wired phone 100 shown in the drawings. If the Bluetooth ID is completely entered at step 404, the controller 222 performs an inquiry process between the master 100 and the slave 102 at step 406. Then, the controller 222 determines at step 408 whether a synchronization process between the master 100 and the slave 102 is completed at the inquiry process. If the synchronization process is completed at step 408, the controller 222 performs a power-saving mode at step 410. When performing the power-saving mode at step 410, a sniff mode time between the slave 102 and the master 100 can be automatically changed to another time at intervals of a predetermined time according to usage frequency of the user's Bluetooth terminal, such that the amount of power consumed by the Bluetooth terminal can be reduced.

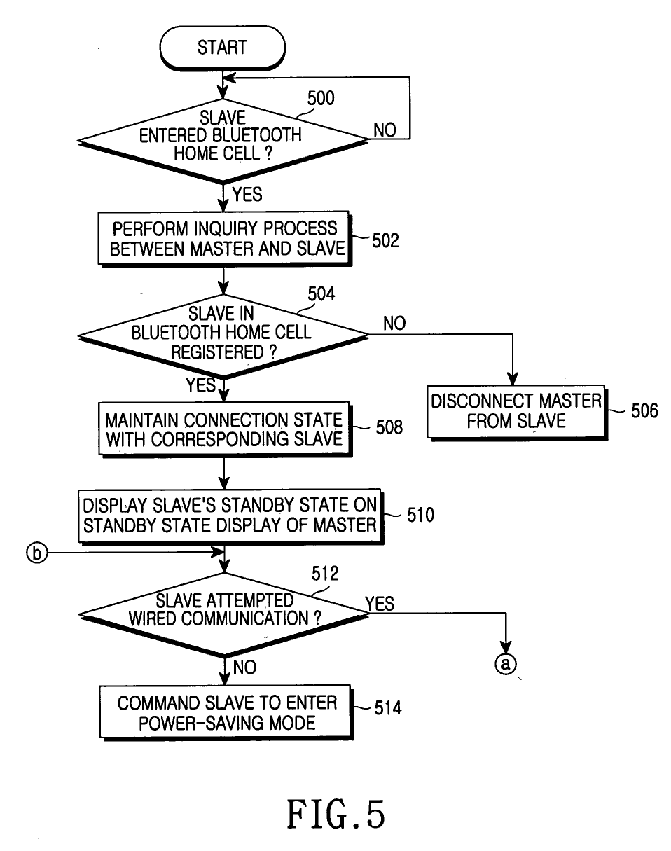

If the Bluetooth wireless terminal 102 completely registers in the wired phone 100 to provide wired communication by performing the steps shown in FIG. 4, a procedure for controlling the Bluetooth wireless terminal 102 to enter the Bluetooth home cell 110 to perform a cell search function will be performed, as described with reference to FIG. 5. FIG. 5 is a flow chart illustrating such a cell search procedure between the Bluetooth wireless terminal 102 entering the Bluetooth home cell 110 and the wired phone 100 in accordance with a preferred embodiment of the present invention. In this case, the wired phone 100 is fixed to a master, and the Bluetooth wireless terminal 102 is fixed to a slave. If a user of the slave 102 enters a home or office located in a Bluetooth home cell 110, a process for connecting the slave 102 with the master is performed such that a standby state for providing the Bluetooth home cell 110 with a wired communication service is maintained. Simultaneously, the slave 102 maintains a standby state for wireless communication. Therefore, the user of the slave 102 can use a wired communication service over a wired network as well as over a wireless communication service over a wireless network within the range of Bluetooth home cell 110.

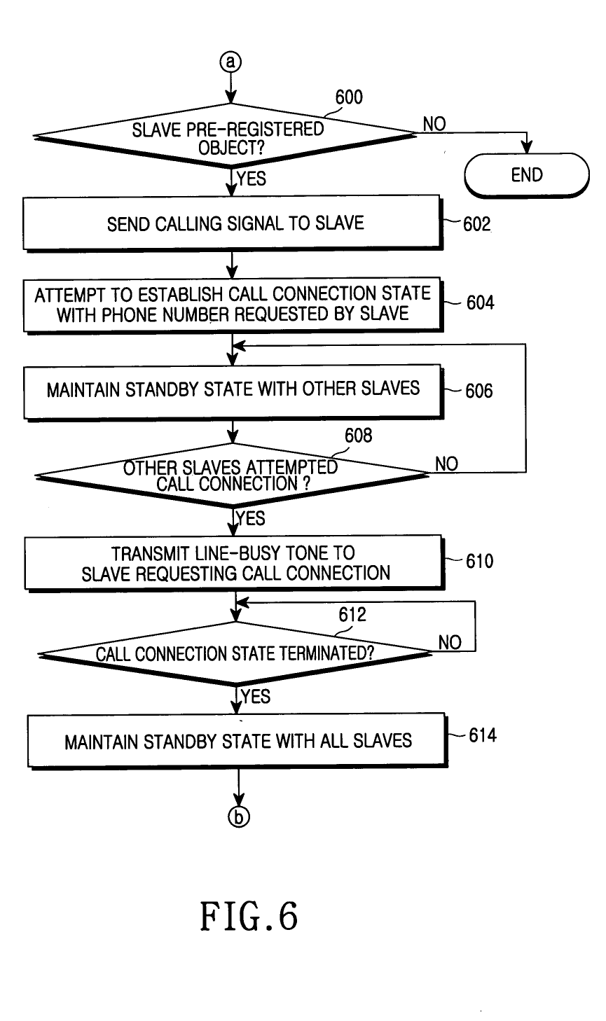

The controller 222 of the master 100 determines whether the slave 102 enters the Bluetooth home cell 110 at step 500. The controller 222 performs an inquiry process for synchronizing the slave 102 located in the Bluetooth home cell 110 at step 502. The controller 222 determines whether the slave 102 is previously registered in the master 100 at step 504. If the slave 102 is previously registered in the master 100 at step 504, i.e., the Bluetooth ID of the slave is pre-stored in the memory 230 at step 504, the controller 222 is connected to the slave 102 to provide a wired communication service at step 508, and a standby state is maintained. Otherwise, if the slave 102 entering the Bluetooth home cell 110 did not previously register in the master 100 at step 504, the master 100 is not connected with the slave 102 at step 506. The slave 102 displays information indicating the standby state capable of receiving a wired communication service on the standby state display 305 of the master 100 at step 510. In this case, the standby state display 305 is composed of LEDs, and switches on the LEDs to indicate such a standby state. In more detail, if the slave 102 enters the Bluetooth home cell 110, the master 100 performs an inquiry process for controlling the slave 102 to perform prescribed Bluetooth initialization, such that the master 100 and the slave 102 enter a standby state. A unique number of the Bluetooth wireless terminal 102 is displayed on the display 304, and at the same time LEDs of the standby state display 305 are illuminated in color (e.g., red, green or blue). Therefore, the user can visually recognize that his or her Bluetooth wireless terminal 102 is connected to the wired phone 100. Thereafter, it is determined at step 512 whether the slave 102 located in the Bluetooth home cell 110 attempts to establish a wired communication state. If it is determined that the slave 102 attempts to establish a wired communication state, steps shown in FIG. 6 associated with such a wired communication attempt are performed. That is, the wired communication request and the wireless communication request are classified separately, and a necessary communication procedure is selectively performed according to the classified information. In order to enable a user of the Bluetooth wireless terminal 102 serving as a slave to receive a wired communication service through a wired phone 100, a specific number different from a number used for attempting to establish wireless communication must be adapted to prevent data collisions between the Bluetooth wireless terminal 102 and the wired phone 100. Therefore, if the Bluetooth wireless terminal 102 enters a phone number of the counterpart terminal, for example, ‘02-111-1111’ or ‘016-222-2222’, etc., the controller 200 of the Bluetooth wireless terminal 102 performs a call connection setup process using the RF unit 202 to provide a general wireless communication service. The Bluetooth wireless terminal 102 first enters a specific ID number to establish a wired communication state with the wired phone 100, such that this specific ID number discriminates between a wired communication service using the Bluetooth terminal and a wireless communication service. For example, a prescribed number key such as “#”, “*”, or “#9” must previously be registered in the Bluetooth wireless terminal 102 and a manufacturer company of the wired phone 100. If the user presses such a prescribed number key, the controller 200 of the Bluetooth wireless terminal 102 requests a wired communication service from the wired phone 100.

In the meantime, if the slave 102 continuously maintains a standby state, the master 100 commands the slave 102 to enter a power-saving mode at step 514. In this case, a sniff mode time between the slave 102 and the master 100 can be automatically changed to another time at intervals of a predetermined time according to usage frequency of the user's Bluetooth terminal, such that the amount of power consumed for the Bluetooth terminal can be reduced. That is, a small amount of power is consumed for a predetermined time during which a usage frequency of the user's Bluetooth terminal is low.

If the Bluetooth wireless terminal 102 transmits a call connection trial signal to the wired phone 100 at step 512, prescribed steps shown in FIG. 6 are performed. FIG. 6 is a flow chart illustrating a procedure for enabling the Bluetooth wireless terminal 102 to establish a wired communication state with the wired phone 100 using a Bluetooth communication service in accordance with a preferred embodiment of the present invention.

If the slave 102 requests a wired communication service from the master 100 at step 512, it is determined whether the slave 102 is a pre-registered object at step 600. If it is determined that the slave 102 is such a pre-registered object at step 600, the master 100 transmits a ring-back tone (RBT) signal to the slave 102 requesting a wired communication service, and thereby the user of the slave 102 can listen to the RBT signal. If the user enters a desired phone number using the key entry unit 206 of the slave 102, the controller 200 transmits the entered phone number to the master 100 by means of the Bluetooth module 20. The master 100 receiving the desired phone number attempts to establish a wired communication state with a counterpart terminal having the received phone number over a typical wired network. If the master 100 establishes a call connection state with the typical wired network by means of the Bluetooth wireless terminal 100, a unique number of the Bluetooth wireless terminal is displayed on the display 304, and an LED of the line-busy state display 306 is switched on. Therefore, the user can visually recognize that his or her Bluetooth wireless terminal is connected to the wired network. Thereafter, slaves other than the above slave 102 sending a call connection trial signal maintain the standby state at step 606. In this case, the Bluetooth IDs of the slaves entering such a standby state are displayed on the information display 304, and at the same time a message indicating such a standby state is displayed on the standby state display 305. If another slave sends a call connection trial signal at step 608, a signal indicating a line-busy state is transmitted to the slaves at step 610. In this case, a voice message or other audible signal for indicating a disabled call connection state may be used instead of outputting a line-busy signal, or a calling tone signal may not be transferred to the slave such that the slave is unable to establish a call connection state. If the slave 102 for a user attempts to establish a wired communication state using the master 100, or enters a line-busy state, slaves other than the slave 102 cannot attempt to establish a wired communication state. If the slave 102 requesting a wired communication service using the master 100 terminates the call connection state at step 612, a standby state is maintained in all of the slaves at step 614.

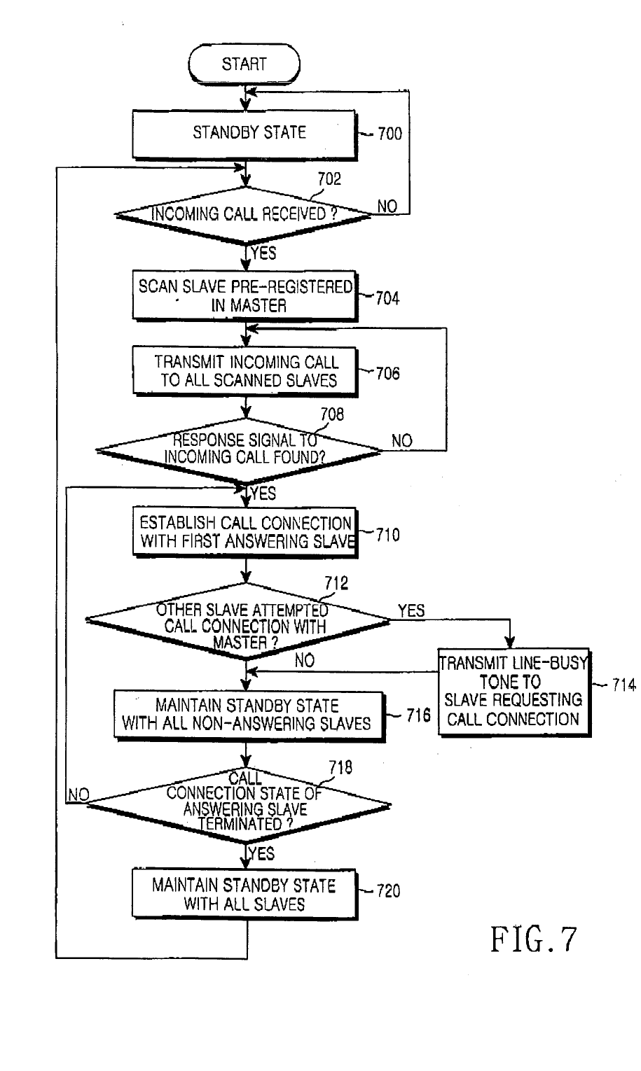

FIG. 7 is a flow chart illustrating a procedure for forming a call path between the wired phone 100 and the Bluetooth wireless terminal 102 when the wired phone 100 receives an incoming call signal in accordance with a preferred embodiment of the present invention. The above procedure for forming a call path between the wired phone 100 and the Bluetooth wireless terminal 102 will now be described with reference to FIG. 7.

The controller 222 of the master 100 maintains a standby state at step 700 until an incoming call signal is received. If an incoming call signal is received at the master 100 at step 702, the controller 222 reads information of all the slaves from the memory 230 at step 704, and transmits at step 706 an incoming call signal to each of the slaves read at the above step 704 until a slave answers the incoming call signal. If any one of the slaves answers the incoming call signal at step 708, the controller 222 establishes a call connection state with a first answering slave from among the slaves at step 710. If a slave other than the current slave (i.e., another Bluetooth wireless terminal) which establishes a call connection state with a called terminal sends a call connection request signal at step 712, the controller 222 sends a line-busy signal to the slave which sent the call connection request signal at step 714 and the procedure continues at step 716. After performing step 712, the controller 222 maintains a standby state with slaves other than the slave responding to the incoming call signal at step 716. Thereafter, the responding slave terminates a call connection state at step 718, and the controller 222 maintains a standby state with the responding slave at step 720. That is, a phone terminal capable of sending an incoming call signal to the wired phone 100 can transmit an incoming call signal to all Bluetooth wireless terminals registering in the wired phone 100 in the range of the Bluetooth home cell 110, and establish a call connection mode with a Bluetooth wireless terminal responding first to the incoming call signal.

As apparent from the above description, the communication system using Bluetooth wireless communication according to the present invention allows a Bluetooth wireless terminal having a Bluetooth module to access a Bluetooth module of the wired phone when the user is located in a prescribed zone (e.g., a home or office) so that the user can receive a wired communication service using his or her Bluetooth wireless terminal, resulting in reduced charges assessed to the user and greater convenience for the user.

In other words, the inventive system allows a user to freely access a wired network and a wireless network using a Bluetooth wireless terminal in the range of a prescribed zone or area, resulting in greater convenience for the user. Furthermore, the inventive system can considerably increase the usage frequency of the wired network, resulting in increased efficiency of the wired network.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A communication apparatus using Bluetooth wireless communication, comprising:
a Bluetooth wireless terminal having an ID (Identification) key for transmitting a communication request signal to a wired phone by means of a first Bluetooth module and a Bluetooth communication process, and for requesting a communication service from the wired phone by means of the Bluetooth module upon receiving the ID key; and
the wired phone having a second Bluetooth module, and connecting the Bluetooth wireless terminal with a wired network upon receiving the communication request signal from the Bluetooth wireless terminal.

2. The apparatus as set forth in claim 1, wherein the Bluetooth wireless terminal includes
a key entry unit having a prescribed key corresponding to an ID number used for requesting a communication service from the wired phone; and
a controller for transmitting wired communication request signal to the wired phone via the first Bluetooth module when the key entry unit receives the ID number from a user, and for transmitting a user-entered phone number to the wired phone via the first Bluetooth module.

3. The apparatus as set forth in claim 1, wherein the wired phone includes
a key entry unit for entering or deleting a Bluetooth ID of the Bluetooth wireless terminal;
a memory for storing the Bluetooth ID of the Bluetooth wireless terminal;
a display for displaying entry and deletion information of the Bluetooth ID and status information of the Bluetooth wireless terminal, said status information being stored in the memory; and
a controller for connecting, upon receiving the communication request signal from the Bluetooth wireless terminal, the Bluetooth wireless terminal with the wired network to provide a communication service when information of the Bluetooth wireless terminal sending the communication request signal is pre-stored in the memory.

4. The apparatus as set forth in claim 3, wherein the key entry unit includes
an ID entry button for entering the Bluetooth ID of the Bluetooth wireless terminal;
an ID deletion button for deleting the Bluetooth ID stored in the memory; and
an English-conversion button for entering the Bluetooth ID, the Bluetooth ID being composed of a combination of English letters and numerals.

5. The apparatus as set forth in claim 3, wherein the display includes
a standby state display for indicating a communication standby state when the Bluetooth wireless terminal gains access to the wired phone; and
a line-busy state display for indicating that the Bluetooth wireless terminal is receiving a communication service using the wired phone.

6. The apparatus as set forth in claim 1, wherein the communication request signal is a wired communication request signal, and
wherein the communication service is a wired communication service.

7. A communication method using Bluetooth wireless communication in a communication system comprised of a Bluetooth wireless terminal having a Bluetooth module, a wired phone, and a wired network, said method for controlling the Bluetooth wireless terminal to receive a communication service, comprising the steps of:
allowing a user to register a Bluetooth ID of the Bluetooth wireless terminal in the wired phone; and
upon receiving a wired communication request signal from the Bluetooth wireless terminal, determining, using the wired phone, whether the Bluetooth wireless terminal is previously registered, and connecting the Bluetooth wireless terminal with the wired network if the Bluetooth wireless terminal is previously registered.

8. The method as set forth in claim 7, further comprising the step of:
informing another Bluetooth wireless terminal, using the wired phone, of a disabled call connection state, if the other Bluetooth wireless terminal sends a new communication request signal prior to terminating a call connection state of the currently connected Bluetooth wireless terminal.

9. The method as set forth in claim 8, wherein the communication service is a wired communication service, and
wherein the communication request signal is a wired communication request signal.
